(19) United States
(12) Patent Application Publication
(10) Pub. No.: US 2003/0146312 A1
(43) Pub. Date: Aug. 7, 2003

(54) Method and device for forced sieving; preparation of an intimate blend of pulverulent products

(75) Inventors: Serge Masson, Avignon (FR); Pierre Martinet, Saint Laurent du Pont (FR); Jean-Marc Ligney, Les Angles (FR); Benoit Duval, Sabran (FR)

Correspondence Address: COHEN, PONTANI, LIEBERMAN & PAVANE, Suite 1210, 551 Fifth Avenue, New York, NY, 10176, US

(73) Assignee: Compagnie Generale Des Matieres Nucleaires

(21) Appl. No.: 10/173,954

(22) Filed: Jun. 18, 2002

(30) Foreign Application Priority Data
Feb. 7, 2002 (FR) 02 01471

(51) Int. Cl. B02C 23/14

(52) U.S. Cl. 241/24.1

(57) ABSTRACT

The subject of the present invention is:

an original method for forced sieving of pulverulent products, suitable for providing said pulverulent products with a granulometric spectrum having a main mode with a narrow distribution centered on a value of a few tens of microns and a proportion of micron-sized particles;

an original device for forced sieving of pulverulent products, suitable for implementing said method;

a method of preparing an intimate blend of at least two pulverulent products; the blend being qualified as intimate in that it involves a blend on the micron scale. Said preparation method includes said forced sieving method.

It has been developed in the context of manufacturing nuclear fuel pellets but is in no way limited to said context.

The subject of the present invention is:

an original method for forced sieving of pulverulent products, suitable for providing said pulverulent products with a granulometric spectrum having a main mode with a narrow distribution centered on a value of a few tens of microns and a proportion of micron-sized particles;

an original device for forced sieving of pulverulent products, suitable for implementing said method;

a method of preparing an intimate blend of at least two pulverulent products; the blend being qualified as intimate in that it involves a blend on the micron scale. Said preparation method includes said forced sieving method.

The applicant has developed the invention in the context of the manufacture of nuclear fuel pellets, these pellets being based on a blend of uranium oxide (UO₂), plutonium oxide (PUO₂) and generally chamotte. Hereinafter, the invention is more particularly described in this context, but a person skilled in the art will easily understand, on reading the following, that it is in no way limited to said context. The methods and device of the invention are suitable for obtaining any type of optimized powders or blend of powders, on the micron scale, especially powders or blends of powders for the pharmaceutical industry.

At present, nuclear fuel pellets (mixed oxide pellets: UO₂ and PuO₂, called MOX pellets), with an adjusted PuO₂ content, are obtained:

from suitable raw materials, familiar to a person skilled in the art: UO₂, PuO₂, chamotte, additives, etc. The PuO₂ powder generally has a mean diameter of 15 μm, and that of UO₂ a mean diameter of a few tens of microns; mean diameters measured by dry laser granulometry, without agitation, by ultrasound;

at the end of implementing a method, called the MIMAS method, which mainly comprises the successive steps below:

preparing a first powder, called the master or primary blend, containing plutonium oxide in an intimate blend (on the micron scale) with uranium oxide and, generally, chamotte;

diluting said first powder with a second powder, called a dilution powder, containing or even consisting of uranium oxide, said first and second powders being intimately blended;

pelleting said intimate blend of said first and second powders;

sintering the pellets obtained;

grinding them.

Because of the low interdiffusion of the uranium and plutonium atoms, under industrial sintering conditions, obtaining the first powder, in the form of a suitable blend, entails a step of breaking up the raw materials involved. This breaking-up step is implemented by dry milling, for example in a ball mill.

This milling certainly causes some breaking up of the particles of the raw material but it also leads to the formation of agglomerates, whose granulometric spectrum is wide. It is therefore appropriate to reduce the size of said agglomerates. For this purpose, a forced sieving step is used on the milled raw material.

Said milled raw material is thus passed through a device combining in its structure a screen (a single-screen sieve) with means (of the blade type or the rotor fitted with arms type) capable of forcing said milled raw material through said screen (of said sieve). This type of device—a forcing sieve—exists commercially. In particular, it may be a Retsch or Frewitt sieve.

The size of the orifices of said screen is a crucial parameter which determines the granulometry of the sieved powder. The need to obtain a very fine first powder (capable of producing an intimate blend with the dilution powder) makes it essential to use screens with very small mesh sizes. Furthermore, in order to meet industrial requirements, the device must be capable of outputting a significant volume of powder. The screen must therefore have a large surface area for through-passage with a large number of small meshes (of small orifices). Said screen is therefore in the form of a crossed array of metal wires with small cross sections, which provides it with the necessary “transparency” required but, inexorably, poor mechanical strength.

The devices used at present for forced sieving therefore have the certain drawback of the fragility of the screen which is within their structure. Said screen frequently breaks, these frequent breakages being moreover difficult to detect during industrial operation in sealed chambers, of the glove box type, chambers within which maintenance operations to replace defective parts are complex and expensive.

The forced sieving can often therefore turn out to be the limiting operation in implementating the method of preparing nuclear fuel pellets, more exactly, in implementating of the first step of said method, that of preparing the first powder or primary blend which comprises, as specified above, the three phases below:

a first phase of blending the raw materials;

a second phase of dry milling them;

a third phase of forced sieving said milled raw materials.

The said first step is followed, as indicated above, by diluting the primary blend obtained with a dilution powder.

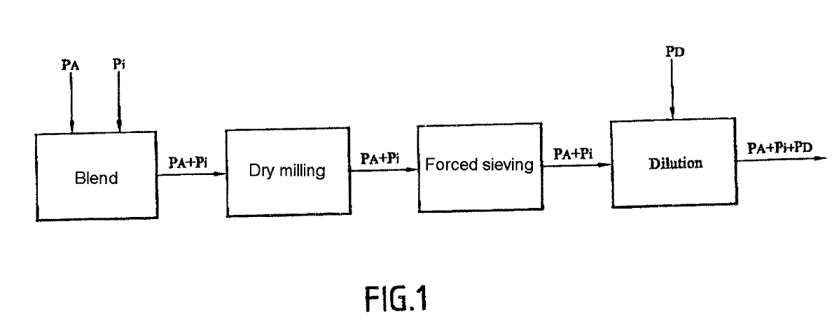

The preparation of said primary blend and its dilution are schematized, in a general context, in the appended FIG. 1. Consideration of this figure already enables the design context of the invention to be better located and helps in understanding said invention.

In this figure, the three phases of preparing the first powder (or primary blend) followed by the second step of dilution are shown.

The following references have been given.

P_{A}: an active principle in powder form which it is desired to blend intimately with at least one other pulverulent product (in the context of manufacturing the nuclear fuel pellets specified above, we have, of course: P_{A}=PuO₂);

Pᵢ: any pulverulent product whose presence is desired in the final blend, an intimate blend of pulverulent products. In the simplest context, we have Pᵢ=P_{D} (see below) (in the context of manufacturing nuclear fuel pellets specified above, we have: Pᵢ=UO₂+generally chamotte +possibly at least one additive in powder form);

P_{D}: the dilution powder, single or multiple component (in the context of manufacturing the nuclear fuel pellets specified above, we have P_{D}=UO₂+possibly at least one additive in powder form (or even chamotte)).

The invention has therefore been developed in such a context of preparing an intimate blend of at least two pulverulent products, a preparation in two steps which comprises forming a primary blend then diluting it. More specifically, it has been developed in the preparation of said primary blend and it will be easily understood on reading the following that it is not limited to this context of preparing intimate blends in two steps.

In general, according to the invention, an improvement to the method and device of forced sieving is proposed, which method and device are useful in obtaining micron-sized powders, blended or otherwise. Within the scope of said improvement, it has been made possible to obtain micron-sized powders or powder blends which are optimized with reference to their homogeneity, their granulometry, their stability, etc. by using robust devices.

The applicant, after having considered this problem of obtaining perfectly homogeneous and stable powders or powder blends, initially realized the benefit, for said powders or powder blends, of having a granulometric spectrum in two modes:

a main mode of particles of a few tens of microns, and

a secondary mode of very fine particles; said very fine particles then being capable of occupying the free spaces between the largest particles, in mutual contact (which has the positive effect of improving the homogeneity of the ensemble of particles and of mechanically stabilizing said ensemble).

Secondly, the applicant proposes obtaining powders or powder blends, with such bimodal granulometric spectra, by forced sieving within devices which do not have the fragility of the devices of this type of the prior art, and capable of generating the same result for the granulometric spectra. To obtain said result, it is proposed, according to the invention, to use a combination of screens of larger mesh size, which are much less fragile, instead of a fragile screen with a very fine mesh size.

According to a first object, the present invention therefore relates to a method for forced sieving of pulverulent products, intended to provide said pulverulent products with a granulometric spectrum having:

a main mode with a narrow distribution centered on a value of a few tens of microns (for example, 40 μm); and:

a proportion of micron-sized particles (secondary mode).

The pulverulent products in question—powders or powder blends—may be of any type and especially consist of pigments, products for the pharmaceutical industry, the agro-foodstuff industry and the nuclear industry (primary UO₂+PuO₂ blends, from breaking up UO₂ and PuO₂ particles: see above). It generally involves powders contaminated by agglomerates (of a mean dimension greater than 100 μm), that it is desired to remove said agglomerates from or even to make them finer, etc.

The forced sieving of the invention comprises the forced passage (in the sense of the prior art) of pulverulent products through (and this, in a characteristic manner) a rigid assembly of at least two superposed screens, in contact with each other, of different aperture size, increasing with reference to the direction of passage of said pulverulent products through said assembly; said aperture size of each of said screens being, in any case, greater than that of the single screen of the same type which, used under the same conditions, would produce a granulometric spectrum of the same type for said pulverulent products.

The originality of the forced sieving method of the invention therefore resides in the use of an ordered rigid assembly of at least two screens or sieves with a large(r) mesh size instead of a single screen with a small mesh size; and this is in order to obtain an identical result. This invention is particularly advantageous:

the concept of superposing several screens, in contact with each other, provides the resulting composite structure with great solidity;

the use of screens with a mesh aperture of greater size makes it possible, without affecting the surface area for through-passage, to work with screens whose constituent wires are markedly thicker and therefore stronger;

the relative arrangement of the screens, constituting the assembly, makes it possible to obtain the intended result in terms of the granulometry of the sieved powders. Moreover, it strengthens the solidity of said assembly (the screen with the largest mesh size being placed below) and favors lower retention of the sieved pulverulent products within said assembly.

The method of the invention is advantageously used for a blend of at least two pulverulent products. It then makes it possible to improve said blend.

Said method of the invention, used on a powder or a powder blend (according to the advantageous variant above), may opportunely be used after dry milling said powder or said powder blend. It is then perfectly appropriate to break up the agglomerates generated during said milling. It is understood that said method of the invention is thus advantageously used in the context of manufacturing nuclear fuel pellets, as specified above.

The forced sieving of the invention is, according to a preferred embodiment, carried out through a rigid assembly of two screens.

According to a second object, the present invention relates to a device for forced sieving of pulverulent products, which is suitable for implementing the forced sieving method as described above. Said device is of the type used in the prior art in that within its structure it combines a sieve with means capable of forcing the passage of said pulverulent products through said sieve. However, in a characteristic manner, said sieve does not comprise a single screen; said sieve comprises a rigid assembly of at least two superposed screens, in contact with each other, of different aperture size, which increases with their separation from said means capable of forcing through- passage; said aperture size of each of said screens of said assembly being, in any case, greater than that of the single screen, of the same type, which, when used under the same conditions, would provide said pulverulent products with a granulometric spectrum of the same type.

The rigid assembly of the superposed screens may result from the simple superposition (by simple layering) of said screens on each other. It may also result from fastening said screens to each other. Within the scope of this second embodiment, it has in particular been possible to weld or fuse together the screens constituting said assembly.

The assembly of the screens constituting the sieve in the sense of the invention can be used as such or arranged on a screen support. The use of such a screen support may prove to be advantageous, in terms of solidity, for handling the assembly.

With regard to the orientation of the screens, they may be oriented a priori in any direction to each other within the assembly.

According to a preferred embodiment, the sieve of the forced sieving device of the invention comprises a rigid assembly of two screens.

This preferred embodiment, both in terms of the device and of the method, has been developed for the purpose of preparing solid (U, Pu)O₂ solutions from PuO₂ and UO₂ powders. It makes it possible to generate primary blends with a main mode having a granulometry of a few tens of microns (for example, 40 μm) and a proportion of micron-sized particles. Said main mode is that of the dilution powder.

We now come to the third object of the present invention, that is a method of preparing an intimate blend (on the micron scale) of pulverulent products, said intimate blend having an adjusted content of at least one of said pulverulent products, termed an active principle. Said method comprises, in a conventional manner:

the formation of a primary blend concentrated in said active principle(s) from said active principle(s) and at least one other pulverulent product;

the dry milling of said primary blend;

the forced sieving of said milled primary blend;

the formation of said intimate blend by diluting said milled and sieved primary blend in an appropriate amount of a dilution powder which has a single-mode granulometric spectrum, with a narrow distribution centered on a value of a few tens of microns.

Characteristically, for the purpose of providing said milled primary blend with a granulometric spectrum having a main mode close to that of the granulometric spectrum of said dilution powder and a proportion of micron-sized particles, said forced sieving is a forced sieving according to the first object of the present invention, as described above, a forced sieving carried out through several superposed screens, with increasing aperture sizes.

According to various embodiments of this preparation method, which may be considered independently of each other and/or in combination:

the same pulverulent product is used instead of another pulverulent product when forming said primary blend and in the dilution powder;

said forced sieving is carried out through a rigid assembly of two screens;

said intimate blend of at least two pulverulent products obtained is conditioned into pellets;

said active principle consists of plutonium oxide powder (PuO₂), said primary blend contains said plutonium oxide powder (PuO₂), uranium oxide powder (UO₂) and generally chamotte and said dilution powder contains uranium oxide powder. In this case, this is the context specified in the introduction to the present text, that is that of preparing nuclear fuel pellets, more specifically, that of preparing the intimate blend of a first powder and second powder.

It will be recalled here that the method described above is in no way limited to said context. Its implementation is particularly advantageous for producing any intimate blend of at least two powders, produced in two steps. Within the scope of the first step, a primary blend with a bimodal granulometry is prepared (by carrying out the original forced sieving of the invention), matched to the single-mode granulometry of the dilution powder which is involved during the second step.

Finally, it is proposed to return to the various aspects of the present invention with reference to the appended figures. Said figures actually illustrate, in an entirely nonlimiting manner, the third object of the present invention, that is the method of preparing an intimate blend of at least two pulverulent products.

FIG. 1 illustrates schematically the various steps of said method, in a general context. It has already been indicated, in the introduction to the present text, how to read this figure in the particular context of preparing nuclear fuel pellets. In this context, we have:

P_{A}=PuO₂

Pᵢ=UO₂+chamotte (generally)+possible additive, etc.

P_{D}=UO₂+possible additive, etc.

FIG. 1 actually illustrates both the prior art and the invention, depending on the method of carrying out the forced sieving (in which the sieve involved comprises one or more screens, with suitable apertures and respective positioning).

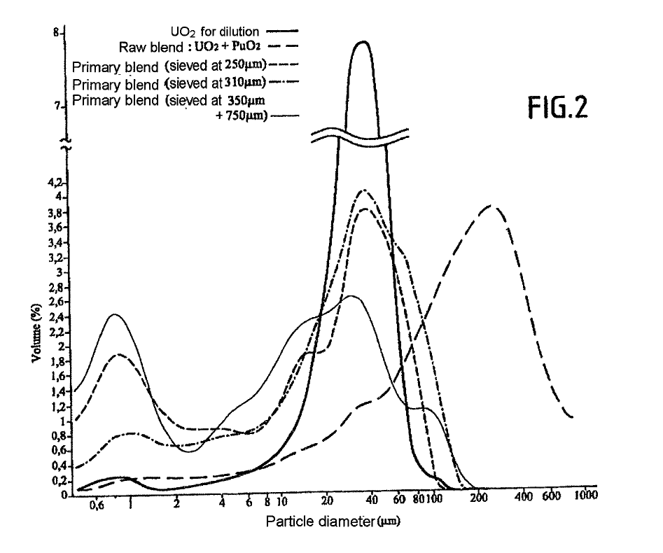

FIG. 2 shows, on a semilogarithmic scale, the granulometric distribution of powders:

UO₂ powder for dilution, capable of forming the desired intimate blend (continuous curve: -)

blend of the unsieved raw materials UO₂+PuO₂, which could be termed a raw blend (semicontinuous curve: - -). This blend contains agglomerates and its granulometry is centered around 200 μm;

primary blend of said raw materials, sieved (by forced sieving) according to the prior art, through a single conventional screen, with a mesh aperture of 250 μm (semicontinuous curve: - - - ). The granulometric distribution is satisfactory in that it is bimodal, of the desired type, but unfortunately the fragility of a 250 μm screen of this type is known (subject to many breakages);

primary blend of said raw materials, sieved (by forced sieving) according to the prior art, through a single conventional mesh, with a mesh aperture of 310 μm (semicontinuous curve: ---). The granulometric distribution is not satisfactory. In fact, the mode of the very fine particles is not very apparent;

primary blend of said raw materials, sieved (by forced sieving) according to the invention, through a rigid assembly of two screens; the first with a mesh aperture of 350 μm and the second with a mesh aperture of 750 μm (continuous curve: -). The granulometric distribution is satisfactory in that it is bimodal, of the desired type: there is a shift of the main mode toward a few tens of microns and the presence, in a significant quantity, of very fine micron-sized particles. These two positive effects are also observed with a single screen of 250 μm. However, the assembly involved here is a solid assembly, not subject to breakages. More specifically, a modified forced sieve of the prior art has been used, equipped with the rigid double screen assembly (350 and 750 μm).

Rigid double screen assemblies of this type have also been tested on various forced sieves, with screens having the following mesh apertures: 200 and 560 μm; 210 and 560 μm; 210 and 710 μm; 250 and 750 μm; 450 and 750 μm.

These tests have given results comparable to those of FIG. 2 with regard to the bimodal granulometric distribution of the desired type, the principal mode varying as a function of the desired granulometry.

On considering these curves, a person skilled in the art will immediately grasp the benefit of the present invention.

1. A method for forced sieving of pulverulent products, suitable for providing said pulverulent products with a granulometric spectrum having a main mode with a narrow distribution centered on a value of a few tens of microns and a proportion of micron-sized particles, wherein it comprises the forced passage of said pulverulent products through a rigid assembly of at least two superposed screens, in contact with each other, of different aperture size, increasing with reference to the direction of passage of said pulverulent products through said assembly; said aperture size of each of said screens of said assembly being, in any case, greater than that of a single screen, of the same type, which, when used under the same conditions, would provide said pulverulent products with a granulometric spectrum of the same type.

2. The forced sieving method as claimed in claim 1, wherein it is carried out on a blend of at least two pulverulent products.

3. The forced sieving method as claimed in claim 1, wherein the sieved pulverulent products have previously been dry milled.

4. The forced sieving method as claimed in claim 1, wherein it comprises the forced passage of said pulverulent products through a rigid assembly of two screens.

5. A device for forced sieving of pulverulent products, suitable for implementing the method according to any one of the preceding claims, combining in its structure a sieve with means capable of forcing the passage of said pulverulent products through said sieve, wherein said sieve comprises a rigid assembly of at least two superposed screens, in contact with each other, of different aperture size, increasing with their separation from said means capable of forcing through-passage; said aperture size of each of said screens of said assembly being, in any case, greater than that of a single screen, of the same type, which, when used under the same conditions, would provide said pulverulent products with a granulometric spectrum of the same type.

6. The forced sieving device as claimed in claim 5, wherein the screens of said sieve are fastened together.

7. The forced sieving device as claimed in claim 5, wherein said sieve is arranged on a screen support.

8. The forced sieving device as claimed in claim 5, wherein said sieve comprises a rigid assembly of two screens.

9. A method of preparing an intimate blend of at least two pulverulent products (P_{A}+P_{D}+Pᵢ), said intimate blend having an adjusted content of at least one of said pulverulent products (P_{A}), termed an active principle;
said method comprising:
forming a primary blend (P_{A}+Pᵢ) concentrated in said active principle(s) (P_{A}) from said active principle(s) (P_{A}) and at least one other pulverulent product (Pᵢ);
the dry milling of said primary blend (P_{A}+Pᵢ);
the forced sieving of said milled primary blend (P_{A}+Pᵢ);
the formation of said intimate blend (P_{A}+Pᵢ+P_{D}) by dilution of said milled and sieved primary blend (P_{A}+Pᵢ), in a suitable amount of a dilution powder (P_{D}) which has a single-mode granulometric spectrum, with a narrow distribution centered on a value of a few tens of microns; and
wherein, for the purpose of providing said milled primary blend (P_{A}+Pᵢ) with a granulometric spectrum having a main mode close to that of the granulometric spectrum of said dilution powder (P_{D}) and a proportion of micron-sized particles, said forced sieving is carried out through a rigid assembly of at least two superposed screens, in contact with each other;
said milled primary blend (P_{A}+Pᵢ) successively passing through screens with an increasing aperture size; the aperture size of each of said screens of said rigid assembly being greater than that of a single screen, of the same type, which, when used under the same conditions, would provide said milled primary blend (P_{A}+Pᵢ) with a granulometric spectrum of the same type.

10. The method as claimed in claim 9, wherein the same pulverulent product is used instead of another pulverulent product in the formation of said primary blend and in the dilution powder.

11. The method as claimed in claim 9, wherein said forced sieving is carried out through a rigid assembly of two screens.

12. The method as claimed in claim 9, wherein said intimate blend of at least two pulverulent products (P_{A}+P_{D}+Pᵢ) obtained is conditioned into pellets.

13. The method as claimed in claim 9, wherein:
said active principle (P_{A}) consists of plutonium oxide powder (PuO₂),
said primary blend (P_{A}+Pᵢ) contains said plutonium oxide powder (PuO₂), uranium oxide powder (UO₂) and in general, chamotte, and wherein
said dilution powder (P_{D}) contains uranium oxide powder (UO₂).
